(19) United States
(12) Patent Application Publication
(10) Pub. No.: US 2002/0169796 A1
(43) Pub. Date: Nov. 14, 2002

(54) System and method for writing a hypermedia file to a multimedia storage device

(76) Inventor: Cynthia L. Schwartz, Tucson, AZ (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 09/855,272

(22) Filed: May 14, 2001

(51) Int. Cl. G09G 5/12

(52) U.S. Cl. 707/500.1

(57) ABSTRACT

A system and method are provided for writing a hypermedia file to a multimedia storage device. The system includes a processor circuit with a processor and a memory. In this respect, the system may be a computer system or other device of like capability. Stored on the memory and executable by the processor is a hypermedia file writer. The hypermedia file writer includes logic that associates a write actuator with a content of the hypermedia file depicted in a graphical user interface generated by an application. The hypermedia file writer also includes logic that packages the hypermedia file for storage in the multimedia storage device upon a manipulation of the write actuator, and, logic that writes the hypermedia file to the multimedia storage device.

### TECHNICAL FIELD

The present invention is generally related to the field of data storage and, more particularly, is related to a system and method for writing a hypermedia file to a multimedia storage device.

### BACKGROUND OF THE INVENTION

As networks that link computers systems and other systems evolve, the speed of data communication increases. For example, earlier network technology used to access the Internet often involved modems with low baud rates that acted as a bottleneck in the flow of data. Current advances have seen increased baud rates with corresponding faster data transfer. Also, advances in data compression techniques have facilitated faster data transfer.

The faster rates of data communication have made new types of data transfer possible. For example, the Internet is currently employed by many to stream video or audio from server to client. Due to this new capability, individuals and entities now create web sites that may be downloaded from the Internet and viewed via a browser that include a variety of content media such as text, video, graphic images, audio, hyperlinks and other elements. Such web sites may comprise a hypermedia file written, for example, in Hypertext Markup Language (HTML), Extensible Markup Language (XML) or other markup language. For example, one may now employ one of several on-line applications to create a hypermedia file that serves as a “Web” greeting card that includes text, video, graphic images, audio and other features. Such a card may be delivered to a loved one via the Internet as is commonplace. Beyond greeting cards, there are many different web sites on the World Wide Web that serve up hypermedia files that include similar elements.

Many users enjoy the enhanced presentation of hypermedia files and often wish to store locally a particular hypermedia file such as, for example, a web page found on the World Wide Web that employs text, video, graphic images, audio and other features. Such a hypermedia file may be stored, for example, on a multimedia storage device. Unfortunately, in the typical case, specialized applications are necessary to accomplish the task of storing a hypermedia file including streamed elements to a multimedia storage device. Many users find such applications complex and difficult to use. As a consequence, users are prevented from saving hypermedia files that include, for example, streamed elements for future enjoyment.

### SUMMARY OF THE INVENTION

In light of the forgoing, the present invention provides for a system for writing a hypermedia file to a multimedia storage device. The present system includes a processor circuit with a processor and a memory. In this respect, the system may be a computer system or other device of like capability. Stored on the memory and executable by the processor is a hypermedia file writer. The hypermedia file writer includes logic that associates a write actuator with a content of the hypermedia file depicted in a graphical user interface generated by an application. The hypermedia file writer also includes logic that packages the hypermedia file for storage in the multimedia storage device upon a manipulation of the write actuator, and, logic that writes the hypermedia file to the multimedia storage device.

In another embodiment, the present invention provides for a program embodied in a computer readable medium for writing a hypermedia file to a multimedia storage device. In this respect, the program includes code that associates a write actuator with a content of the hypermedia file depicted in a graphical user interface generated by an application. The program further includes code that packages the hypermedia file for storage in the multimedia storage device upon a manipulation of the write actuator, and, code that writes the hypermedia file to the multimedia storage device.

Finally, the present invention may be viewed as a method for writing a hypermedia file to a multimedia storage device. In this respect, the present method comprises the steps of depicting a content of the hypermedia file in a graphical user interface using an application in a computer system, associating a write actuator with the content of the hypermedia file depicted in the graphical user interface, packaging the hypermedia file for storage in the multimedia storage device upon a manipulation of the write actuator, and writing the hypermedia file to the multimedia storage device.

Other features and advantages of the present invention will become apparent to a person with ordinary skill in the art in view of the following drawings and detailed description. It is intended that all such additional features and advantages be included herein within the scope of the present invention.

### BRIEF DESCRIPTION OF THE SEVERAL VIEWS OF THE DRAWINGS

The invention can be understood with reference to the following drawings. The components in the drawings are not necessarily to scale.

Also, in the drawings, like reference numerals designate corresponding parts throughout the several views.

FIG. 1 is a box diagram of a client/server network according to an aspect of the present invention;

FIG. 2 is a drawing of a graphical user interface including a depiction of a hypermedia file in the client of FIG. 1 according to another aspect of the present invention;

FIG. 3 is a drawing of a second graphical user interface depicted by the client of FIG. 1 according to another aspect of the present invention;

FIG. 4 is a drawing of a third graphical user interface depicted by the client of FIG. 1 according to another aspect of the present invention;

FIG. 5 is a drawing of a fourth graphical user interface depicted by the client of FIG. 1 according to another aspect of the present invention;

FIG. 6A is a flow chart of a hypermedia file writer executed by the client of FIG. 1 to write a hypermedia file to a multimedia storage device; and

FIG. 6B is a second flow chart further depicting the hypermedia file writer of FIG. 6A.

### DETAILED DESCRIPTION OF THE INVENTION

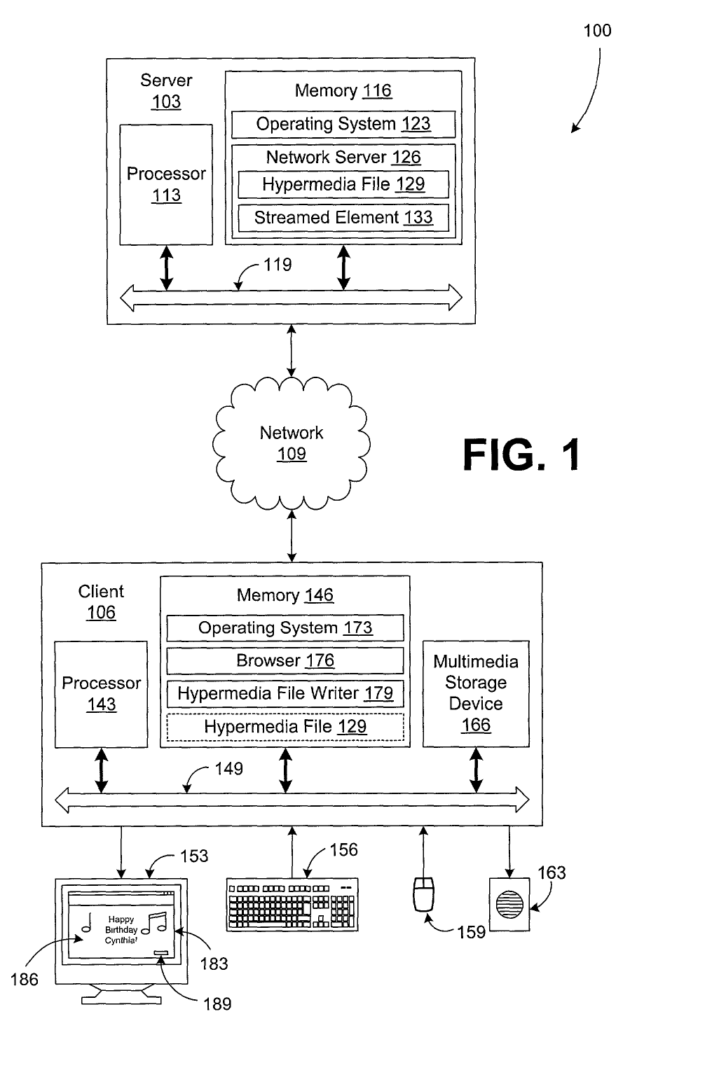

With reference to FIG. 1, shown is a server/client network 100 according to an aspect of the present invention. The server/client network 100 includes a server 103 and a client 106, both of which are coupled to a network 109. To best describe the present invention, first the physical makeup of the server/client network 100 followed by a description of its operation. Thereafter, various aspects of the present invention are discussed in greater detail. The server 103 includes a processor circuit with a processor 113 and a memory 116, both of which are coupled to a local interface 119. The local interface 119 may comprise, for example, a data bus with an accompanying control/address bus as is generally known by those with ordinary skill in the art. In this regard, the server 103 may be a computer system or other system with like capability.

Stored on the memory 116 and executable by the processor 113 is an operating system 123 and a network server 126. The network server 126 may be, for example, a web server or other network server. The network server 126 serves up various files such as web pages that may comprise one or more hypermedia files 129. Each of the hypermedia files 129 may include various elements such as one or more streamed elements 133 and non-streamed elements (not shown) as is generally known by those with ordinary skill in the art. In this regard, the hypermedia file 129 may be written in hypertext markup language (HTML) or extensible markup language (XML) or other markup language as is generally known by those with ordinary skill in the art. Thus, the hypermedia file 129 may reference and therefore include a combination of several different elements, including but not limited to, text, video, animation, graphic images, pictures or images, sound or audio, and hyperlinks, etc.

The streamed element 133 is generally indicated in the hypermedia file 129 by a uniform resource locator, for example, and is fed to the client 106 in a streamed fashion when the hypermedia file 129 is served to the client 106 in response to a request from the client 106. In this respect, the client 106 may execute or otherwise render the beginning of the streamed element 133 even though the entire file has not been received. In this respect, the streamed element 133 may be, for example, a video file, audio file, or other similar file as is generally known by those with ordinary skill in the art.

The client 106 also includes a processor 143 and a memory 146, both of which are coupled to a local interface 149. In this respect, the local interface 149 may comprise a data bus with an accompanying control/address bus as is generally known by those with ordinary skill in the art. Thus, the client 106 may comprise, for example, a computer system or other such system. The client 106 also includes a number of peripheral devices, namely, a display device 153, a keyboard 156, a mouse 159, and an audio speaker 163. The display device 153, keyboard 156, mouse 159, and audio speaker 163 are all generally coupled to the local interface 149 using an appropriate interface device such as, an interface card or other such device as is known by those with ordinary skill in the art and not discussed herein in detail.

The client 106 may also include other peripheral devices such as a keypad, touch pad, touch screen, microphone, scanner, joystick, or one or more push buttons, one or more indicator lights, a printer, and other devices, etc. The display device 153 may be, for example, a cathode ray tube (CRT), a liquid crystal display screen, a gas plasma-based flat panel display, or other type of display device, etc.

The client 106 also includes a multimedia storage device 166 that is coupled to the local interface 149 by way of an appropriate multimedia storage device interface as is generally known by those with ordinary skill in the art. The multimedia storage device 166 is defined herein as a memory device that is capable of storing a hypermedia file that may comprise a combination of audio, video, text, graphics, graphical images, animation, and other elements. In this respect, the multimedia storage device 166 may comprise, for example, a compact disc (CD) accessed via a compact disc drive, hard disk drives, read-only memory (ROM), or other like memory device that includes suitable capacity and speed of operation.

Stored on the memory 146 and executable by the processor 143 is an operating system 173, a browser 176, a hypermedia file writer 179, and the hypermedia file 129 that is downloaded to the client 106 from the server 103. When executed, the browser 176 generates a graphical user interface 183 that can depict the graphical content 186 of the hypermedia file 129 as is generally known by those with ordinary skill in the art. The hypermedia file 129 is defined by the fact that it comprises or references at least two multimedia elements. In one embodiment, the multimedia elements in the hypermedia file include at least a video or an audio element. These video or audio elements may be streamed or non-streamed. In another embodiment, the multimedia elements may be any two of several elements, including streamed or non-streamed video, streamed or non-streamed audio, animation, text, pictures or images, graphical images, and other elements. The hypermedia file writer 179 generates a write actuator 189 that is displayed in the graphical user interface 183 concurrent with the content 186. The hypermedia file writer 179 also performs other functions as will be discussed.

In addition, the network 109 includes, for example, the Internet, wide area networks (WANs), local area networks, or other suitable networks, etc., or any combination of two or more such networks. The server 103 and the client 106 are both coupled to the network 109 to facilitate data communication to and from the network 109 in any one of a number of ways that are generally known by those of ordinary skill in the art. For example, the server 103 and/or the client 106 may be linked to the network 109 through various devices such as, for example, network cards, modems, or other such communications devices.

Each of the memories 116 and 146 may include both volatile and nonvolatile memory components. Volatile components are those that do not retain data values upon loss of power. Nonvolatile components are those that retain data upon a loss of power. Thus, each of the memories 116 and 146 may comprise, for example, random access memory (RAM), read-only memory (ROM), hard disk drives, floppy disks accessed via an associated floppy disk drive, compact discs accessed via a compact disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other such of memory device.

Also, each of the processors 113 and 143 may represent multiple processors and each of the memories 116 and 146 may represent multiple memories that operate in parallel processing circuits, respectively. In such a case, the local interfaces 119 and 149 may be an appropriate network that facilitates communication between any two of the multiple processors, between any processor and any of the memories, or between any two of the memories 116 and 146, etc. The processors 113 and 143 may be electrical or optical in nature.

The operating systems 123 and 173 are executed to control the allocation and usage of hardware resources in the server 103 and client 106, respectively. Specifically, in the server 103 and client 106, the operating systems 123 and 173 control the allocation and usage of the memories 116 and 146, processing time, and the peripheral devices as well as performing other functionality. In this manner, the operating systems 123 and 173 serve as the foundation on which applications depend as is generally known by those with ordinary skill in the art.

Next a general description of the operation of the hypermedia file writer 179 is provided in the context of the present invention. To begin, assume that a user of the client 106 wishes to download the hypermedia file 129 from the server 103. The user may do this by entering the uniform resource locator (URL) of the hypermedia file 129 on the server 103 using the browser 176 as is conventional, or some other application may be employed. After the hypermedia file 129 is downloaded from the server 103, the browser 176 generates the graphical content 186 of the hypermedia file 129 on the graphical user interface 183 on the display device 153. Specifically, the browser 176 may depict any video, animation, graphical images, pictures or images, text, or other elements within the graphical user interface 183 that is associated with the hypermedia file 129. The browser 176 may also cause the generation of any audio output associated with the hypermedia file 129 by way of the audio speaker 163 using an appropriate audio reproduction application in the client 106, etc. The hypermedia file writer 179 detects the generation of the content 186 in the graphical user interface 183 including any video, animation, graphical images, text, pictures or images, and/or any reproduction of any audio file associated with the hypermedia file 129 through the audio speaker 163. When such is detected, the hypermedia file writer 179 generates and displays the write actuator 189 in the graphical user interface 183 concurrent with the content 186 of the hypermedia file 129. Assuming that a user enjoys the content 186 of the hypermedia file 129, then they might wish to store the hypermedia file 129 in the multimedia storage device 166 for future local access. This is often desirable as there is never a guarantee that the hypermedia file 129 will continue to be available on the server 103 through the network server 126.

To save the hypermedia file 129 and all of its associated elements including streamed elements 133, the user “clicks” on the write actuator 189 by manipulating the mouse 159. Specifically, the concept of “clicking” on a particular actuator or button within a graphical user interface 183 entails the movement of a cursor on the display device 153 by manipulation of the mouse 159 to the desired actuator or button and then pressing an appropriate button on the mouse 159 as is generally known by those with ordinary skill in the art.

Once the user clicks on the write actuator 189, then the hypermedia file writer 179 first determines whether any elements in the hypermedia file 129 are restricted in the sense that they cannot be saved in the client 106. Such may be the case, for example, when particular items are the subject of copyright protection as may be the case with many streamed elements 133, etc. If there are restricted elements in the hypermedia file 129, then the client 106 seeks to have the restrictions released by the server 103. If this is not possible, then the client 106 informs the user that the hypermedia file 129 may only be saved without the restricted elements giving the user the option of abandoning the save attempt.

Assuming that there are no restricted elements in the hypermedia file 129 or that the user wishes to save any non-restricted elements, then the hypermedia file writer 179 packages the hypermedia file 129 in a matter that facilitates the storage of the hypermedia file 129 on the multimedia storage device 166. In particular, in packaging the hypermedia file 129, all non-restricted or released streamed elements 133 that are stored in the server 103 are downloaded to the client 106 and stored in the multimedia storage device 166 by the hypermedia file writer 179 as normally the browser 176 does not temporarily store such files in the memory 146. Also, any uniform resource locators included within the hypermedia file 129 that reference any elements stored in the server 103 or other server on the network 109 are altered such that the same elements are then referenced as being located on the multimedia storage device 166. The hypermedia file writer 179 then writes the hypermedia file 129 to the multimedia storage device 166 along with all elements that are associated with the hypermedia file 129 including the streamed elements 133. In this manner, the hypermedia file writer 179 provides a means by which a user may store a hypermedia file 129 on a local multimedia storage device 166. This provides a significant advantage in that the average user is then capable of storing hypermedia files 129 as such without the use of a separate application or and the necessary expertise to use such an application.

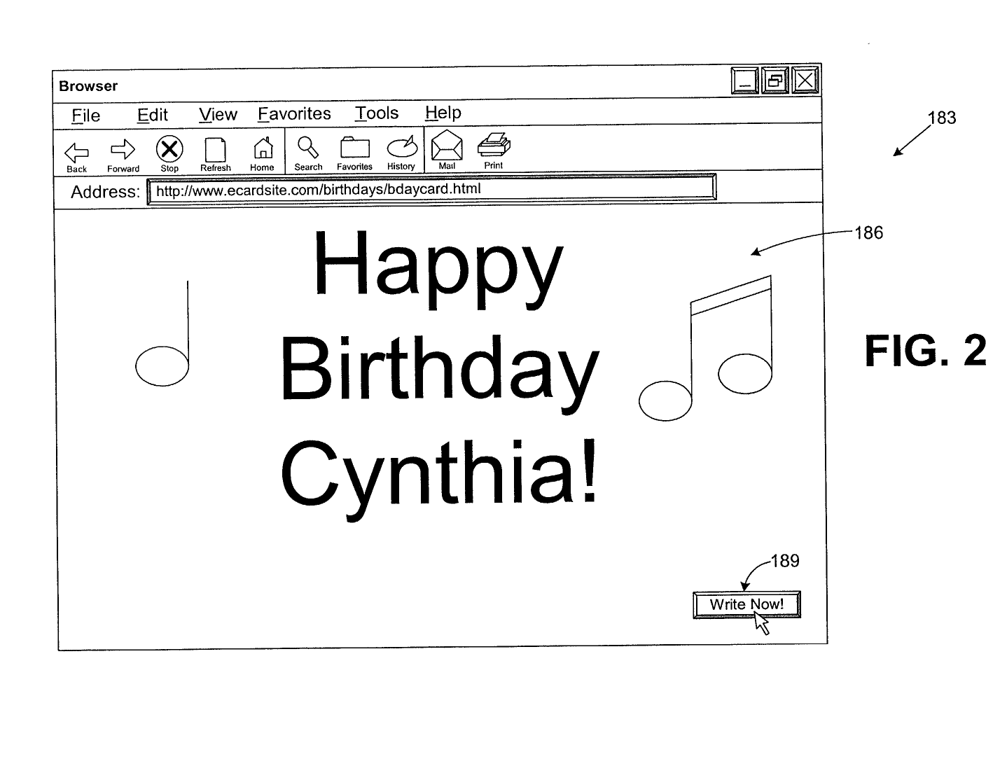

Referring then to FIG. 2, shown is the graphical user interface 183 depicted on the display device 153 (FIG. 1) by the browser 176 (FIG. 1) when it interprets the hypermedia file 129 (FIG. 1). As shown, the graphical user interface 183 includes the content 186 of the hypermedia file 129. Also, the write actuator 189 is depicted in the lower right hand corner of the graphical user interface 183. In order to save what they see and hear when the browser 176 interprets the hypermedia file 129, the user may click on the write actuator 189 that may comprise a button or other appropriate graphical element.

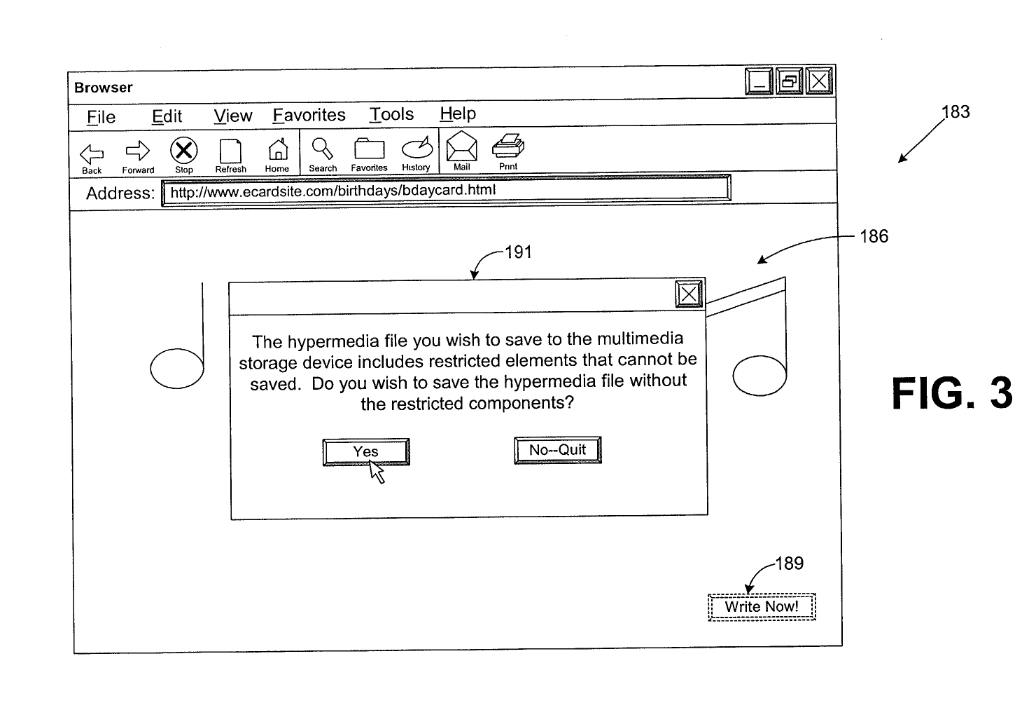

Turning to FIG. 3, shown is a depiction of the graphical user interface 183 that includes a first dialog box 191 according to an aspect of the present invention. The first dialog box 191 is generated by the hypermedia file writer 179 (FIG. 1) when a user clicks on the write actuator 189 and the hypermedia file writer 179 determines that there are restricted elements that cannot be saved. The first dialog box 191 informs the user that the restricted elements cannot be written to the multimedia storage device 166 (FIG. 1) and asks the user if they wish to continue to save the hypermedia file 129 (FIG. 1) without the restricted elements. The user may click on the appropriate button within the first dialog box 191 as desired.

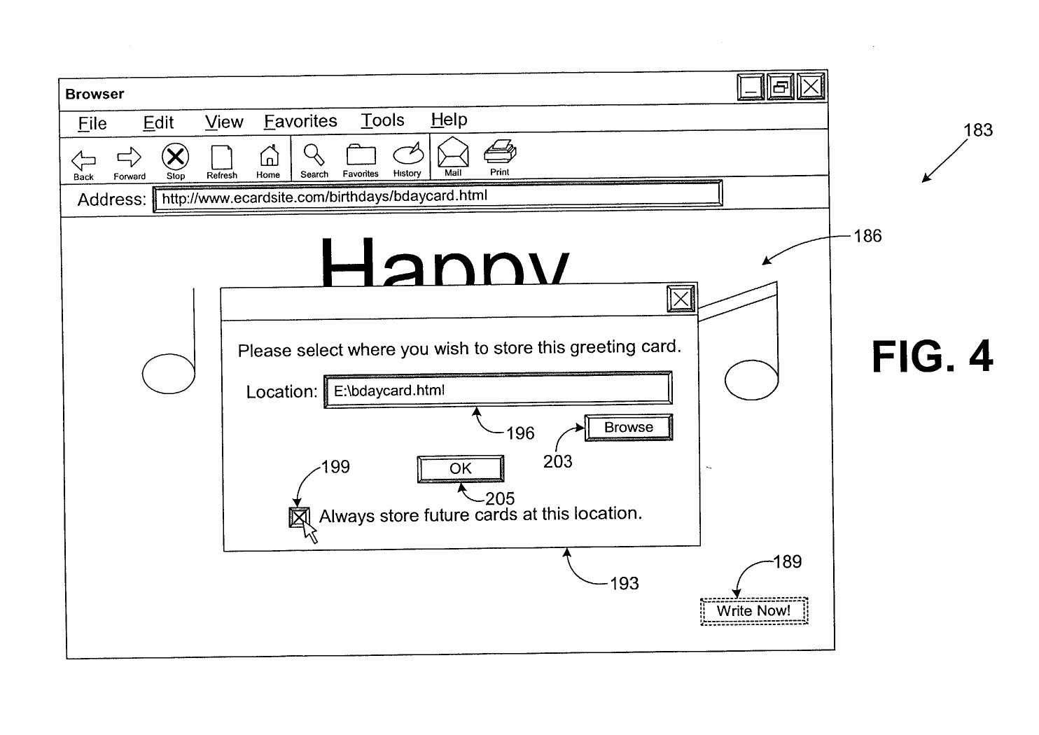

With reference to FIG. 4, shown is a depiction of the graphical user interface 183 that includes a second dialog box 193 according to an aspect of the present invention. The second dialog box 193 is generated by the hypermedia file writer 179 (FIG. 1) when a user clicks on the write actuator 189 and a default location for the multimedia storage device 166 has not been previously indicated to the hypermedia file writer 179. The second dialog box 193 therefore includes a location field 196 that indicates a memory location to which the hypermedia file 129 (FIG. 1) is to be written. Also, the second dialog box 193 includes a default indicator 199 that indicates that the location indicated in the location field 196 is to be maintained by the hypermedia file writer 179 for storage of all future files. A browse button 203 in the second dialog box 193 may be clicked on by the user in order to browse through the various memory devices included in the client 106 to identify the multimedia storage device 166 as is generally known by those with ordinary skill in the art. When the multimedia storage device 166 is identified, the user may click on the OK button 205 to proceed. Note that a further dialog box may be presented to the user that allows a prior identified multimedia storage device 166 to be changed as can be appreciated by one with ordinary skill in the art.

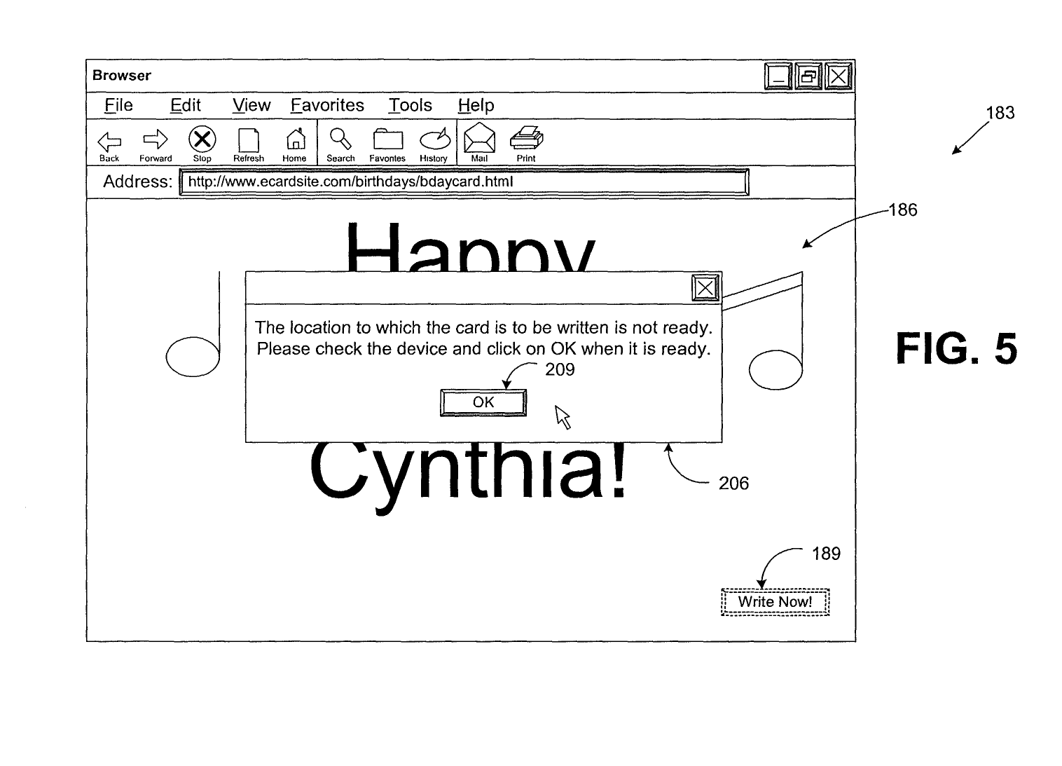

Turning to FIG. 5, shown is the graphical user interface 183 that includes the depiction of a third dialog box 206 according to another aspect of the present invention. The third dialog box 206 comprises a prompt that informs a user that the multimedia storage device 166 (FIG. 1) is not in a ready state to receive the hypermedia file 129 (FIG. 1). In particular, in the case that the multimedia storage device 166 is a compact disc drive, for example, a compact disc may need to be installed therein or other such problem as is generally known by those with ordinary skill in the art. The user may click on the OK button 209 when the multimedia storage device 166 is made ready. When the OK button 209 is clicked, the hypermedia file writer 179 is informed that it should attempt once again to write the hypermedia file 129 to the multimedia storage device 166, such process previously having been interrupted by the fact that the multimedia storage device 166 was not in a ready state.

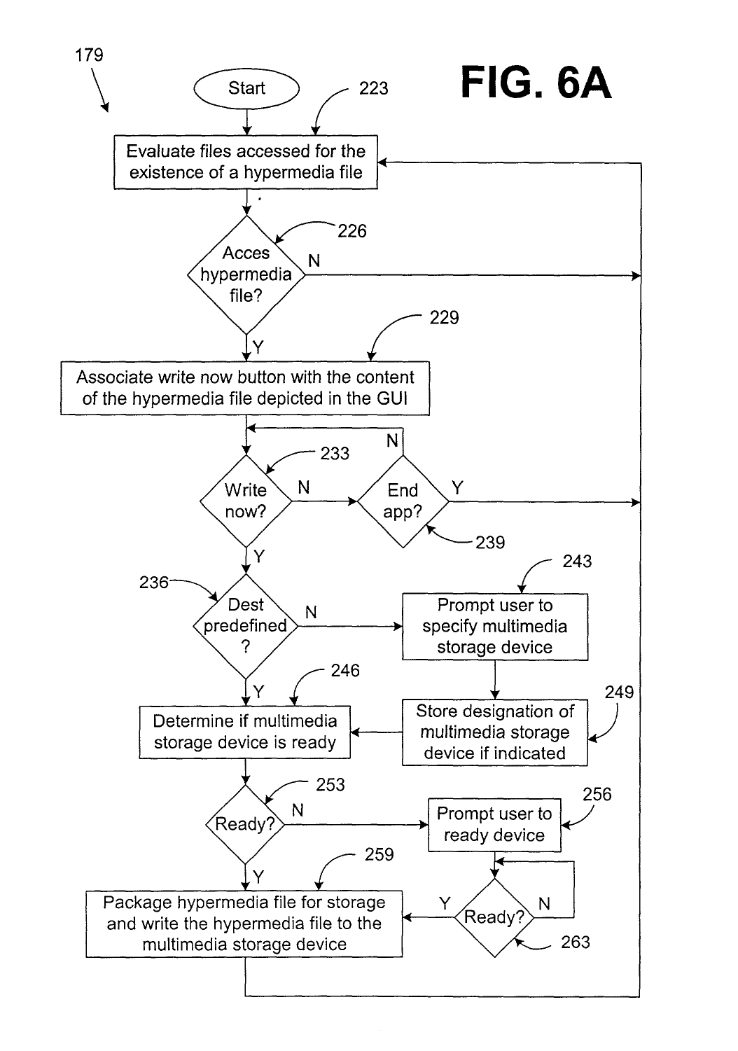

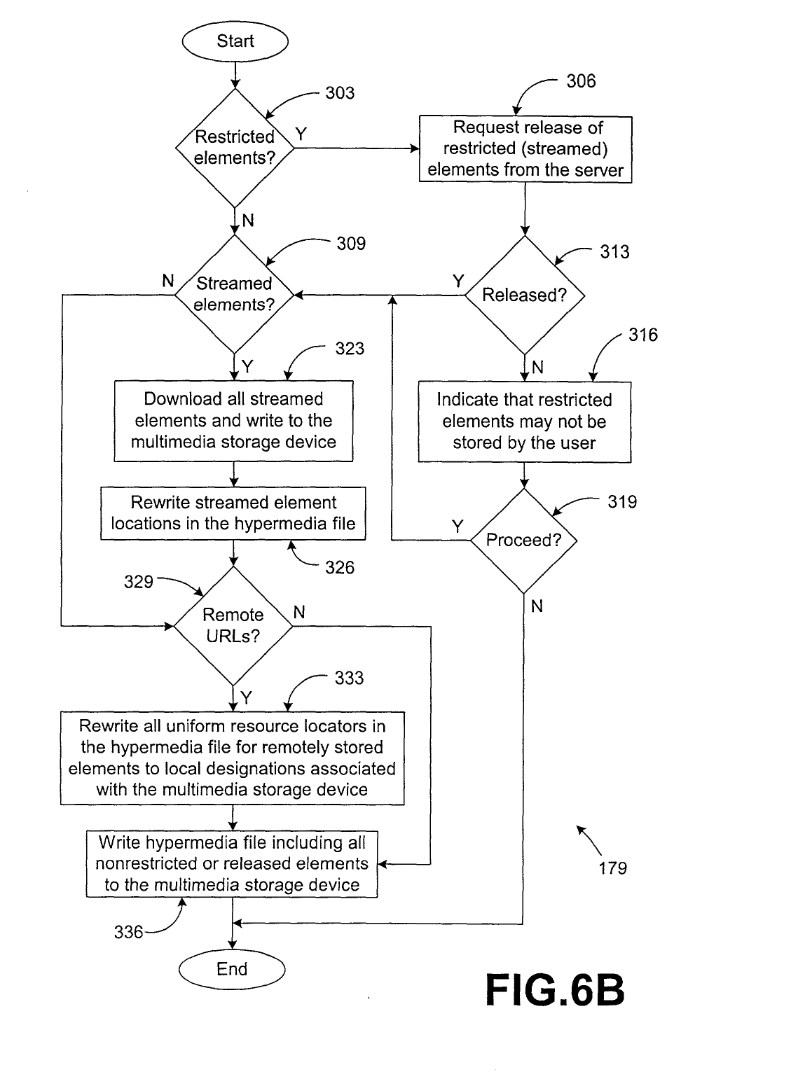

With reference to FIG. 6A, shown is a flow chart of the hypermedia file writer 179 according to an aspect of the present invention. The hypermedia file writer 179 is executed in the client 106 (FIG. 1) in order to write the hypermedia file 129 (FIG. 1) to the multimedia storage device 166 (FIG. 1). Alternatively, the flow chart of FIG. 6A may be viewed as depicting steps in a method implemented in the client 106 to write the hypermedia file 129 to the multimedia storage device 166. The hypermedia file writer 179 is advantageous in that it allows a user to store the hypermedia file 129 in a multimedia storage device 166 with little or no input on the part of the user. Specifically, the hypermedia file writer 179 includes the ability to communicate directly with the multimedia storage device 166 without the execution of an intervening application.

The hypermedia file writer 179 begins with box 223 in which all files accessed by the browser 176 or other application are evaluated to determine whether they may be a hypermedia file 129 that can be written to the multimedia storage device 166. This evaluation entails, for example, determining the various kinds of elements referenced and/or included in the hypermedia file 129. Thereafter, the hypermedia file writer proceeds to box 226 in which it is determined whether a file accessed by the browser 176 (FIG. 1) or other application is a hypermedia file 129. If not, then the hypermedia file writer 179 reverts back to box 223. On the other hand, if a hypermedia file 129 was accessed, then the hypermedia file writer 179 proceeds to box 229 in which the write actuator 189 (FIG. 2) is associated with the content 186 that is depicted in the graphical user interface 183 (FIG. 2) by the browser 176. Specifically, this is accomplished by generating and displaying the write actuator 189 concurrently with the content 186 of the hypermedia file 129 on the graphical user interface 183.

Thereafter the hypermedia file writer 179 proceeds to box 233 in which it is determined whether the write actuator 189 (FIG. 2) has been clicked on by the user indicating a desire to write the hypermedia file 129 to the multimedia storage device 166 (FIG. 1). If so then the hypermedia file writer 179 proceeds to box 236. Otherwise, the hypermedia file writer 179 moves to box 239. In box 239, the hypermedia file writer 179 determines whether the browser 176 (FIG. 1) or other application that is employed to generate the content 186 of the hypermedia file 129 in the graphical user interface 183 (FIG. 2) has ceased to perform this function. This may occur, for example, in the case where a user employs the browser 176 to view a different web page or other file that is not a hypermedia file 129. This may also occur where the user ends the operation of the browser 176 all together. If such is the case then the hypermedia file writer 179 reverts back to box 223. Otherwise the hypermedia file writer 179 reverts to box 233. Thus, upon reaching boxes 233 and 239, the hypermedia file writer 179 waits for the user either to initiate the writing of the hypermedia file 129 to the multimedia storage device 166 or it waits until the user ceases viewing the content of the hypermedia file 129.

Assuming that the hypermedia file writer 179 proceeds to box 236, the hypermedia file writer 179 determines whether the location of the multimedia storage device 166 has been predefined in previous interaction with the hypermedia file writer 179. For example, the location of the multimedia storage device 166 may have been identified when a prior hypermedia file 129 was saved, such location being stored by the hypermedia file writer 179 in the memory 146 as a default. Assuming that the destination is not predefined, then the hypermedia file writer 179 proceeds to box 243. Otherwise, the hypermedia file writer 179 proceeds to box 246. In box 243, the user is prompted to specify a memory device to act as the multimedia storage device 166 in the client 106. This may be done, for example, by generating and displaying the second dialog box 193 (FIG. 4) on the display device 153 (FIG. 1). Thereafter, the hypermedia file writer 179 moves to box 249 in which the designation obtained from the second dialog box 193 is stored in the memory 146 (FIG. 1) for future storage of subsequent hypermedia files 129. Thereafter, the hypermedia file writer 179 proceeds to box 246 as shown.

In box 246 the hypermedia file writer 179 determines if the multimedia storage device 166 is in a ready state so as to allow the hypermedia file 129 to be written thereto. In box 253, if the multimedia storage device 166 is not ready, then the hypermedia file writer 179 proceeds to box 256. Otherwise, the hypermedia file writer 179 proceeds to box 259. In box 256 the user is prompted to make the multimedia storage device 166 ready. This is done, for example, by generating the third dialog box 206 (FIG. 5) that informs the user to take such action as is necessary to place the multimedia storage device 166 into a ready state such as, for example, placing a compact disc in a compact disc drive or other necessary action. In box 263, if the multimedia storage device 166 is in a ready state, then the hypermedia file writer 179 proceeds to box 259. In box 259, the hypermedia file writer 179 packages or prepares the hypermedia file 129 for storage and writes the hypermedia file 129 to the multimedia storage device 166. Thereafter, the hypermedia file writer 179 reverts back to box 223 in order to detect access to the next occurrence of a hypermedia file 129 by the browser 176 or other application for which the storage on the multimedia storage device 166 may be desirable.

With reference to FIG. 6B, shown is a flow chart that further illustrates the functionality of the hypermedia file writer 179. In particular, the flow chart of FIG. 6B further describes the function of packaging the hypermedia file 129 (FIG. 1) for storage and writing the hypermedia file 129 to the multimedia storage device 166 (FIG. 1) as discussed with reference to box 259 (FIG. 6A). Alternatively, the flow chart of FIG. 6B may be viewed as steps implemented in the client 106 to package the hypermedia file 129 for storage and to write the hypermedia file 129 to the multimedia storage device 166.

Beginning with box 303, the hypermedia file writer 179 first determines whether there are any restricted elements in the hypermedia file 129. Such would be the case, for example, with many streamed elements 133 (FIG. 1) and any other elements that include restrictions on their use including storage to memory or printing, etc. If such is the case, then the hypermedia file writer 179 proceeds to box 306. Otherwise, the hypermedia file writer 179 proceeds to box 309. In box 306, the hypermedia file writer 179 requests the release of the restricted elements from the server 103 (FIG. 1). Specifically, the release of the restrictions on the elements is requested by transmitting a request to the server 103 employing a predefined protocol between the client 106 and the server 103 for such requests. The server 103 thus includes the logic to respond to such a request. For example, the server 103 my transmit further markup pages to the client 106 to consummate a financial transaction whereby the user of the client 106 purchases the ability to save the hypermedia file 129 in the multimedia storage device 166.

In box 313, if the server 103 releases the restrictions on the desired elements for storage in the multimedia storage device 166, then the hypermedia file writer proceeds to box 309. Otherwise, the hypermedia file writer 179 to box 316. In box 316 the hypermedia file writer 179 indicates to the user of the client 106 that restricted elements within the hypermedia file 129 can not be stored to the multimedia storage device due to restrictions imposed by the server 103. This may be done, for example, by generating and displaying the first dialog box 191 in the graphical user interface 183 thereby informing the user.

Thereafter, in box 319, the hypermedia file writer 179 determines whether it will proceed with the writing of the hypermedia file 129 to the multimedia storage device 166. In particular, this may be determined based upon an appropriate input by the user in response to the dialog box created with respect to box 316. Assuming that the user wishes to proceed, then the hypermedia file writer 179 reverts back to box 309. Otherwise, the hypermedia file writer 179 ends accordingly.

With reference back to box 309, the hypermedia file writer 179 determines whether there are any streamed elements in the hypermedia file 129. If such is the case then the hypermedia file writer proceeds to box 323 in which all streamed elements are downloaded and written to the multimedia storage device 166. Thereafter, in box 326 the element locations within the hypermedia file 129 are rewritten to reflect the new location of the streamed elements stored in the multimedia storage device 166. Thereafter the multimedia file writer 179 proceeds to box 329. However, with reference back to box 309, assuming that there are no streamed elements 133 (FIG. 1) in the hypermedia file 129, then the hypermedia file writer 179 proceeds to box 329.

In box 329, hypermedia file writer 179 determines whether there are any remote uniform resource locators in the hypermedia file 129. If such is the case then the hypermedia file writer 179 proceeds to box 333. Otherwise the hypermedia file writer 179 moves to box 336. In box 333, all uniform resource locators in the hypermedia file are rewritten to local designations that are associated with the multimedia storage device 166. Thereafter the hypermedia file writer 179 proceeds to box 336 in which the hypermedia file 129 and all non-restricted or released elements are written to the multimedia storage device 166. Thereafter, the hypermedia file writer 179 ends.

Although the hypermedia file writer 179 of the present invention is embodied in software or code executed by general purpose hardware as discussed above, as an alternative the hypermedia file writer 179 may also be embodied in dedicated hardware or a combination of software/general purpose hardware and dedicated hardware. If embodied in dedicated hardware, the hypermedia file writer 179 can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

The flow charts of FIGS. 6A and 6B show the architecture, functionality, and operation of an implementation of the hypermedia file writer 179. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flow charts of FIGS. 6A and 6B show a specific order of execution, it is understood that the order of execution may differ from that which is depicted. For example, the order of execution of two or more blocks may be scrambled relative to the order shown. Also, two or more blocks shown in succession in FIGS. 6A and 6B may be executed concurrently or with partial concurrence. In addition, any number of counters, state variables, warning semaphores, or messages might be added to the logical flow described herein, for purposes of enhanced useability, accounting, performance measurement, or providing troubleshooting aids, etc. It is understood that all such variations are within the scope of the present invention. Also, the flow charts of FIGS. 6A and 6B show are relatively self-explanatory and are understood by those with ordinary skill in the art to the extent that software and/or hardware can be created by one with ordinary skill in the art to carry out the various logical functions as described herein.

Also, where the hypermedia file writer 179 comprises software or code, it can be embodied in any computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present invention, a “computer-readable medium” can be any medium that can contain, store, or maintain the hypermedia file writer 179 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Although the invention is shown and described with respect to certain preferred embodiments, it is obvious that equivalents and modifications will occur to others skilled in the art upon the reading and understanding of the specification. The present invention includes all such equivalents and modifications, and is limited only by the scope of the claims.

I/we claim:

1. A method for writing a hypermedia file to a multimedia storage device, comprising:
depicting a content of the hypermedia file in a graphical user interface using an application in a computer system;
associating a write actuator with the content of the hypermedia file depicted in the graphical user interface;
packaging the hypermedia file for storage in the multimedia storage device upon a manipulation of the write actuator; and
writing the hypermedia file to the multimedia storage device.

2. The method of claim 1, wherein the step of associating the write actuator with the content of the hypermedia file depicted in the graphical user interface further comprises depicting the write actuator in the graphical user interface concurrent with the content of the hypermedia file.

3. The method of claim 1, further comprising:
detecting a depiction of the content of the hypermedia file in the graphical user interface; and
wherein the step of associating the write actuator with the content of the hypermedia file depicted in the graphical user interface occurs upon a detection of the depiction of the content of the hypermedia file in the graphical user interface.

4. The method of claim 1, wherein the step of packaging the hypermedia file for storage in the multimedia storage device upon the manipulation of the write actuator further comprises downloading a streamed element of the hypermedia file.

5. The method of claim 4, wherein the step of writing the hypermedia file to the multimedia storage device further comprises writing the streamed element to the multimedia storage device.

6. The method of claim 1, wherein the step of packaging the hypermedia file for storage in the multimedia storage device upon the manipulation of the write actuator further comprises rewriting a uniform resource locator in the hypermedia file associated with a remotely stored element to a local designation associated with the multimedia storage device.

7. The method of claim 1, further comprising determining if the multimedia storage device is in a ready state for writing the hypermedia file thereto.

8. The method of claim 7, further comprising generating a prompt in a graphical user interface informing a user that the multimedia storage device is not in a ready state when it has been determined that the multimedia storage device is not in the ready state.

9. A program embodied in a computer readable medium for writing a hypermedia file to a multimedia storage device, comprising:
code that associates a write actuator with a content of the hypermedia file depicted in a graphical user interface generated by an application;
code that packages the hypermedia file for storage in the multimedia storage device upon a manipulation of the write actuator; and
code that writes the hypermedia file to the multimedia storage device.

10. The program embodied in a computer readable medium of claim 9, wherein the code that associates the write actuator with the content of the hypermedia file depicted in the graphical user interface generated by the application further comprises code that generates the write actuator in the graphical user interface concurrent with the content of the hypermedia file.

11. The program embodied in a computer readable medium of claim 9, further comprising:
code that detects a depiction of the content of the hypermedia file in the graphical user interface; and
wherein the code that associates a write actuator with the content of the hypermedia file depicted in a graphical user interface generated by an application further comprises code that associates the write actuator with the content of the hypermedia file upon a detection of the depiction of the content of the hypermedia file in the graphical user interface.

12. The program embodied in a computer readable medium of claim 9, wherein the code that packages the hypermedia file for storage in the multimedia storage device upon the manipulation of the write actuator further comprises code that downloads a streamed element of the hypermedia file.

13. The program embodied in a computer readable medium of claim 12, wherein the code that writes the hypermedia file to the multimedia storage device further comprises code that writes the streamed element to the multimedia storage device.

14. The program embodied in a computer readable medium of claim 9, wherein the code that packages the hypermedia file for storage in the multimedia storage device upon the manipulation of the write actuator further comprises code that rewrites a uniform resource locator in the hypermedia file associated with a remotely stored element to a local designation associated with the multimedia storage device.

15. The program embodied in a computer readable medium of claim 9, further comprising determining if the multimedia storage device is in a ready state for writing the hypermedia file thereto.

16. The program embodied in a computer readable medium of claim 15, further comprising generating a prompt in a graphical user interface informing a user that the multimedia storage device is not in a ready state when it has been determined that the multimedia storage device is not in the ready state.

17. A system for writing a hypermedia file to a multimedia storage device, comprising:
a processor circuit including a processor and a memory;
write logic stored in the memory and executable by the processor, the write logic comprising:
logic that associates a write actuator with a content of the hypermedia file depicted in a graphical user interface generated by an application;
logic that packages the hypermedia file for storage in the multimedia storage device upon a manipulation of the write actuator; and
logic that writes the hypermedia file to the multimedia storage device.

18. The system of claim 17, wherein the logic that associates the write actuator with the content of the hypermedia file depicted in the graphical user interface generated by the application further comprises logic that generates the write actuator in the graphical user interface concurrent with the content of the hypermedia file.

19. The system of claim 17, wherein the logic that packages the hypermedia file for storage in the multimedia storage device upon the manipulation of the write actuator further comprises logic that downloads a streamed element of the hypermedia file.

20. The system of claim 19, wherein the logic that writes the hypermedia file to the multimedia storage device further comprises logic that writes the streamed element to the multimedia storage device.

21. The system of claim 17, wherein the logic that packages the hypermedia file for storage in the multimedia storage device upon the manipulation of the write actuator further comprises logic that rewrites a uniform resource locator in the hypermedia file associated with a remotely stored element to a local designation associated with the multimedia storage device.

22. A system for writing a hypermedia file to a multimedia storage device, comprising:
means for depicting the content of the hypermedia file in a graphical user interface using an application in a computer system;
means for associating a write actuator with the content of the hypermedia file depicted in the graphical user interface;
means for packaging the hypermedia file for storage in the multimedia storage device upon a manipulation of the write actuator; and
means for writing the hypermedia file to the multimedia storage device.

23. The system of claim 22, wherein the means for associating the write actuator with the content of the hypermedia file depicted in the graphical user interface further comprises means for depicting the write actuator in the graphical user interface concurrent with the content of the hypermedia file.

24. The system of claim 22, further comprising means for detecting a depiction of the hypermedia file in the graphical user interface.

25. The system of claim 22, wherein the means for packaging the hypermedia file for storage in the multimedia storage device upon the manipulation of the write actuator further comprises means for downloading a streamed element of the hypermedia file.

26. The system of claim 25, wherein the means for writing the hypermedia file to the multimedia storage device further comprises means for writing the streamed element to the multimedia storage device.

27. The system of claim 22, wherein the means for packaging the hypermedia file for storage in the multimedia storage device upon the manipulation of the write actuator further comprises means for rewriting a uniform resource locator in the hypermedia file associated with a remotely stored element to a local designation associated with the multimedia storage device.
